(19) United States
(12) Patent Application Publication
(10) Pub. No.: US 2009/0126027 A1
(43) Pub. Date: May 14, 2009

(54) FILE ACCESSING AND RETRIEVAL USING SOFT DIGITAL RIGHTS MANAGEMENT TECHNOLOGY

(75) Inventor: Thomas W. Lynch, Galveston, TX (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Rambus, Inc., Los Altos, CA (US)

(21) Appl. No.: 11/937,272

(22) Filed: Nov. 8, 2007

(51) Int. Cl. G06F 7/04

(52) U.S. Cl. 726/29; 726/27

(57) ABSTRACT

The subject matter disclosed herein relates to a method and/or system for enabling access to computer file content using an open routine having a proprietary argument.

### BACKGROUND

1. Field

The subject matter disclosed herein relates to computer file accessing and retrieval using digital rights management.

2. Information

The ease with which digital media may be copied and distributed causes proprietary license enforcement to be a challenging activity in the digital world. In the absence of digital rights management (DRM) protections, all media that appears in a file system may be copied using standard methods of graphical user interface (GUI) or shell copy commands, which in turn call the operating system's file system interface routines. Today, for example, to copy an unprotected CD or DVD on a Mac, Windows, or some Unix systems, one simply drags and drops the CD icon to a file on the computer, an application, or to another memory device. In times past reading CDs required using ‘ripping’ software to gather the media followed by using CD writer drivers and applications. The incremental effort required for ripping reduced the number of people who were willing to rip rather than buy.

When DRM functions properly, attempting to illegally copy restricted material, even by ‘ripping’ will fail. Such a failure may be followed by a message that may be as simple as “permission denied” or as complex as a “buy it here” advertisement.

However, conventional DRM technologies have been used with only limited success for controlling the reproduction and use of digital media such as video, music, e-books and software. For example, an early DRM standard called ‘CSS’ used a combination of encryption and agreements with manufacturers that limited the inclusion of features on players to protect content. According to this standard one of the features not allowed on a player was a high quality auxiliary output [see Wikipedia, Digital Rights Management]. Within three years of the introduction of CSS the program DeCSS became available, which could circumvent CSS. Other DRM schemes have also been circumvented. For example, a way around another DRM standard, called ‘AACS’, which was to be used with blue ray disks, was discovered even before its widespread distribution.

DRM schemes employed on general purpose computers suffer from a number of problems, one of which is a virtualization flaw. Hardware devices interface with the operating system through software drivers. For example, a D/A converter that drives an amplifier that drives a speaker requires a digital sample stream to be sent to it. This sample stream will conventionally come from a file that is being manipulated by a player. The player will call operating system routines with the stream data, and these routines will in turn send the stream to the hardware specific driver. Since device drivers are insulated from the application by the operating system they can be replaced, typically without the application even knowing. Such replacements may make copies of the intelligible stream as it goes to the device.

As a second virtualization approach, one may note that an application has no way of knowing if a physical device is even present, so a device driver could simply write its output to a file. Furthermore, physical devices accept input often through computer as memory or i/o space, and this can be hijacked. This is an intrinsic constraint of central processing.

Hence as a third virtualization approach, it is entirely possible for the device itself to be replaced or shadowed with a program that reads the data that would go to the device.

As a fourth approach, whole computers may be virtualized using software that emulates the hardware. In this case, everything is visible to the underlying machine that runs the virtual machine.

Because devices can be virtualized, it follows that the software may be tricked into writing the decoded data to a data file instead of having it rendered on the screen or played by a speaker. This concept is illustrated in FIGS. 1a and 1b, which show a disk device 200 producing a data stream 205 that is subsequently decoded by a player 210, thus producing a decoded data stream 215. In FIG. 1a, the decoded data stream 215 is received by an output device 220 to display an image or produce an audio output. In FIG. 1b, however, a virtual output device 230 replaces the output device 220, wherein the virtual output device 230 may be a data file 240 that is built from received data of the decoded data stream 215. A simple example of this is using a player's screen capture facility to copy every frame in a movie.

DRM programs that employ encryption suffer from a second flaw, namely that encryption keys appear in memory while the DRM program is running. For example, an ICE (in circuit emulator) is a device that can be used to replace a processor in a system with an instrument that can record the states of pins and internal registers. When a computer system that has a ICE replacement for the processor runs the DRM program, the processor buses and registers may be monitored for the appearance of the key. Instead of using ICE it is possible with modern technology to open the processor and microprobe internal points. There are also less expensive methods for watching memory and processor state, including logic analyzers, emulation software, debugging software, among others. Each of these has varying efficacy, availability, and expense.

A third problem that has plagued conventional DRM systems is the cross purposes flaw. Media businesses depend on the sales of media, for sales to be successful the media must be distributed, and the end customer must be able to play it. DRM runs cross purposes to these goals as it strives to limit distribution and limit ease of play. For example, many DRM schemes require special hardware or firmware in the media reading device. This limits the market to customers who own a DRM decoding enabled device. In turn, these DRM decode enabled devices and software must interoperate with existing media. The media company Bertelsmann ran into this problem with the DRM used on its audio CDs, as some of their customers could not read their CDs, unrelated CDs could not be read on protected systems, and some computers even crashed when the software was present. DRM sometimes attempt to leverage their security by leveraging operating system security. Sony BMG became the target of a class action law suit when their DRM technology defeated the computer security system when it ran [Wikipedia, Digital Rights Management].

The goal of a DRM system may vary. Some DRM systems are designed to be perfect. These systems inevitably fall short of that goal, typically by suffering from one of the flaws described above. Another possible goal for a DRM system is to make the digital rights enforcement problem no worse than the conventional DRM problem. This may be called soft DRM. With conventional DRM most people would rather buy content than steal it, as it is more difficult or more risky to make a copy than to purchase the item. The usual reader of a book would rather purchase a book at a book store than sit all day in front of a copy machine while making a copy. Most people who have money to spend on books in the first place find their time to be worth more than the cost of the book. Even when leaving out time as an inhibiting factor, the end result of photo copying a book is either not as high quality as the original, or the very materials for the one-off run will cost more than buying a legal copy. Certainly there are exceptions, such as large scale thieves who automate the process, but such theives would not be stopped by any of the DRM systems proposed to date anyway. Thus the philosophy of soft DRM is that copying should be difficult and/or risky enough that the usual customer will find purchasing a more attractive option than copying. Putting this in more formal terms, the cheat criteria says: when the risk cost plus the materials cost plus the labor cost is greater than the purchase cost, the consumer will perceive purchasing to be preferable to copying. The risk cost is the probability of getting caught times the expense of being caught.

An ethical consumer will purchase an item even when the cheat criteria shows cheating to be less costly, though the greater the cheat value, the smaller and more extreme the ethical buyer population becomes. In the converse case, the sociopathic consumer will attempt to make a copy even when doing so is more costly than purchasing. The higher the cost for cheating, the smaller and more extreme the sociopathic consumer population becomes. In some case the sociopathic role is romanticized, as in the case of the Internet hacker community. In which case the population distribution may be skewed. In general, one assumes that the highly ethical and highly sociopathic populations are the tails of the distribution, and have small contributions to, or detract little from, the bottom line. An exception to this conclusion exists when there is a magic formula that can be easily distributed.

Most DRM schemes proposed to date suffer from a fallibility of some magic formula. In this case, after a highly sociopathic or romantic consumer discovers and distributes the magic formula the cheat criteria changes dramatically in favor of illegal copying.

The ideal soft DRM technology would not suffer from the virtualization flaw, the encryption key in memory flaw, the cross purposes flaw, or the magic formula flaw, would take the romance out of its defeat, all the while causing illegal copying or other activities not sanctioned by the proprietary license agreement to be more costly than purchasing the product as perceived by most consumers. And it would do all this without constricting the market for the media.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1a shows a disk device producing a decoded data stream received by an output device to display an image or produce an audio output.

FIG. 1b shows a disk device producing a decoded data stream received by a virtual output device, which may be a data file.

FIG. 2 is a schematic diagram illustrating an auditing platform to audit a device's operating system via the internet, according to an embodiment.

FIG. 3 is a schematic diagram showing detail of a device and a data file, according to an embodiment.

FIG. 4 is a schematic diagram of a device and a data file, according to another embodiment.

FIG. 5 is a schematic diagram illustrating user and internet information transfer between a computing platform, according to an embodiment.

FIG. 6 is a flow diagram illustrating a process for accessing a data file using a general open routine.

FIG. 7 is a flow diagram illustrating a process for accessing a data file using an open routine, according to an embodiment.

FIG. 8 is a flow diagram illustrating a process for accessing a data file using an open routine, according to another embodiment.

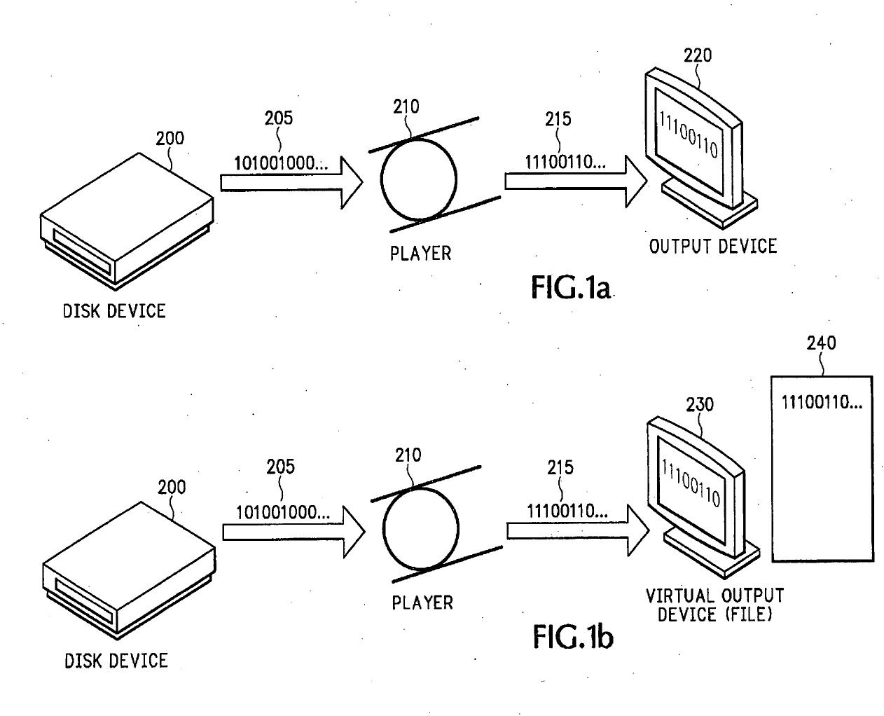

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

To help facilitate explanation and description of the following embodiments, a description of some principles and properties now follows.

Media may reside in an abstraction called a file. In absence of direct device manipulation, opening a file requires program control to flow through an operating system routine. At the source code level, this routine is typically called “open”. In an embodiment, drag and drop operations, shell commands, and standard software may open files through a file system interface and may not manipulate devices directly. In one embodiment, programs that would manipulate a device may directly require administrative or supervisor permissions and thus may be specially installed. A person with access to a given computer may determine if such a program has been installed.

In one embodiment, files may exist within an abstraction called a file system. Within the file system files have extrinsic properties that are maintained in a directory listing, and they have intrinsic properties such as content. For example, content may comprise copyrighted media distributed under license.

According to an embodiment, examples of extrinsic properties for a file include its name, its owner, and its access permissions. These properties are called extrinsic because they can be changed without modifying the contents of the file. This approach may be used with only small variations in most file systems, including those used on windows systems including NTFS, on DOS with its FAT based file system, on UNIX systems such as Linux with a plethora of file systems including the most popular EXT, and platform independent file systems such as ISS 960.

According to an embodiment, in response to an application's attempt to access a file, the application may call a standard library routine, which in turn may call operating system-supported routines for accessing the device where the file resides. Various devices such as USB sticks, CD drives, DVD drives, and hard-drives may be abstracted to the same standard library routines. In the C, C++, Java, Perl, Lisp, Pascal, Fortran, standard libraries, a file may be opened with a routine called open( ), read with various routines, and it may be closed either by exiting the program scope or by a call to the standard library close( ) routine, for example. Other languages may use a similar approach to file i/o. Other operating systems may provide a similar interface for opening files. Calls to these functions may be embedded in the standard language calls, or sometimes are accessible directly from a high level language. Thus, Unix, Windows, Dos, and many other operating systems may provide an open( ) call for opening files. In one embodiment, the operating system level open( ) call may require simpler types on its argument list than does the standard library analog that may be called from a standard library. The standard library file interfaces may be buffered, whereas the operating system level ones may not be buffered.

The open call, whether it is a standard library open call provided to a high level language, or a low level call that is part of the operating system's abstraction of file systems, may accept certain parameters which help the operating system find a file and determine if the calling program is being run by a user who owns the file. One such parameter includes the file name. This may be matched by the operating system with the extrinsic file name property for identifying the file. In most file systems, each file also may have an extrinsic owner property. This property may not be passed to the open routine, but instead a calling program may be run by a user with the same name as the owner, or access to the file may be denied by the operating system. The operating system associates a user to every running program. Files may also have extrinsic group properties, in which case the user who ran the program that is calling the open routine may belong to a specified group. Those skilled in the art may recognize a number of variations to the ownership schemes, including ACLS, which is a technique for keeping an explicit list of users.

In an embodiment, additional extrinsic file properties facilitate soft digital rights management.

In one embodiment, two extrinsic properties may be added to a file. One extrinsic property may be a single bit that indicates whether the file is copyrighted or not. The second extrinsic property may be a copyright agent. This second property may be an integer of managed property right agents, such that each agent, or the majority of agents, has a unique identifier. Alternatively, this second property may be a text string stating the name of the agent. Accordingly, the open command interface to the file system may be modified, so that the open command may optionally accept a copyright agent identifier or string.

In this particular embodiment, when a program calls the open command, but does not provide an agent, the open will fail if the file is marked to be copyrighted. If the open command has a copyright agent specified, then that specifier must match the agent identifier or string, or the open fails.

Another embodiment includes a third extrinsic property which may be a key field. If the parameter specified in the open command matches the key in the open command, then the open command will succeed. In such a case, the key may be a secret held by a player. It may be the case that the file contents are coded in a manner that is only apparent to the player. In a variation of this embodiment, there may yet be another parameter provided to the open command, and that value may be used by the file system for decrypting the file.

In still another embodiment, the open command may return an extrinsic property of the file to the player, and then the player may make use of this property to find a key for decrypting the file. One method for finding this key is to contact a server over the Internet while providing the value returned from the open command.

In another embodiment, the file system may allow the extrinsic file properties to be extended with a property value list. Such a property value list may be recursive, where values are in turn property values list. This property values list may contain arbitrary information used by either the operating system or the application which is opening the file.

According to an embodiment, a computing platform, associated with a device, includes an operating system that comprises an open routine. Such an open routine may define at least a file identifier argument and a proprietary argument, which are passed to the open routine when it is called. The open routine may conditionally access a data file associated with the file identifier argument based, at least in part, on a comparison of the proprietary argument with a proprietary string associated with the data file.

In one embodiment, the open routine further defines a copyright argument so that the open routine may conditionally access the data file associated with the file identifier argument based, at least in part, on a comparison of the copyright argument with a copyright string associated with the data file.

A proprietary string may comprise a character string, an integer key, or a pointer to a table that contains at least one character string or integer key, just to name a few examples. The proprietary argument may be included in an argument list of application source code provided by a user of the device. In a particular embodiment, the operating system may receive the proprietary argument from the internet.

A data file, for example, may comprise encoded signals or information that is representative of audio, video, text, still images, and/or other data. The device may comprise a personal computer, a video player, an audio player, an audio-video player, a personal digital assistant (PDA), a cell phone, an MP3 player, just to name a few examples. However, these are merely examples and claimed subject matter is not limited in this respect.

In an embodiment, a computing platform may comprise a processor and a memory for storing and executing machine-readable instructions for hosting one or more applications. Such applications may be adapted to access a data file using an open routine that is part of an operating system. Accessing the data file may comprise reading the data file, writing to the data file, and copying the data file, just to name a few examples.

According to an embodiment, information may be received from a device that has accessed a data file. Such information may be descriptive of an open routine hosted on the device and used to access the data file. Here, such information may be used to determine whether the device is/was authorized to access the data file. As indicated above, such an open routine may be included in an operating system hosted on the device.

In a particular embodiment, the open routine defines multiple arguments that are passed to the open routine when the open routine is called. Such arguments may include at least a file identifier argument and a proprietary argument. Here, such an open routine may conditionally access a data file associated with the file identifier argument based, at least in part, on a comparison of the proprietary argument with a proprietary string associated with the data file.

Accordingly, a device that has accessed a proprietary data file may be distinguished as either authentic or non authentic based, at least in part, on whether its operating system includes the open routine that defines at least the file identifier argument and the proprietary argument, and conditionally permits access based, at least in part, on the aforementioned comparison. Thus, a theft of such protected material may be indicated by a device that lacks the open routine defining the proprietary argument but has nevertheless accessed a proprietary data file.

In another embodiment, illegally accessing protected material may require the unusual action of modifying a non authentic device to include an operating system having an open routine defining the proprietary argument. In this manner, the presence and use of such an unusual action becomes a “smoking gun” to a detectable crime.

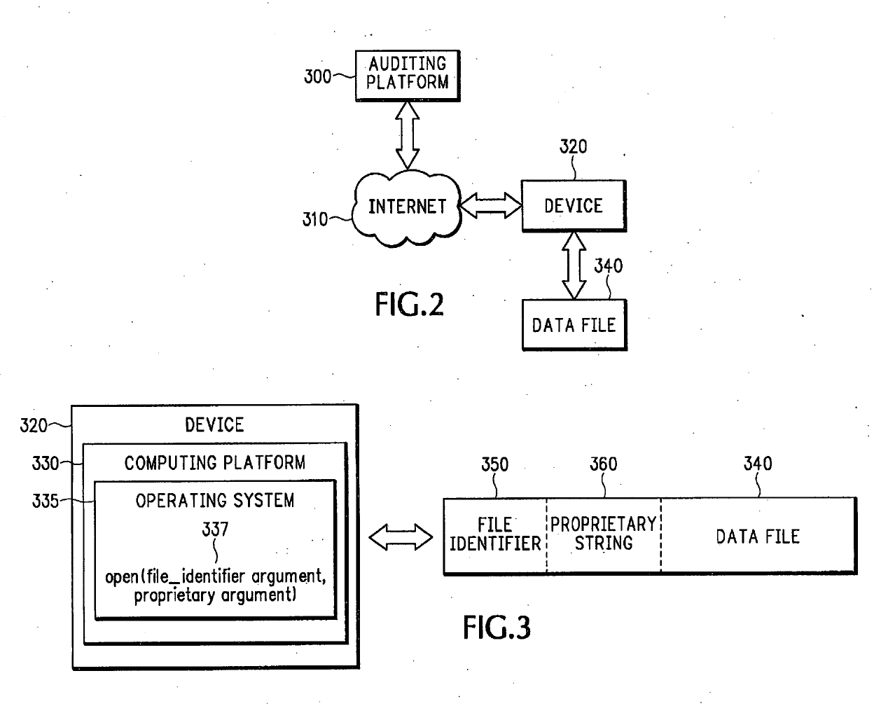

FIG. 2 is a schematic diagram illustrating an auditing platform 300 adapted for auditing and/or monitoring an operating system of a device 320 via internet 310, according to an embodiment. Device 320 may be used to access a data file 340, which may be copyrighted, or otherwise protected. Device 320 may, for example, be a personal computer, a DVD player, cellular phone, MP3 player, television, or an audio CD player, just to name a few examples. Device 320 may be configured to access the data file 340, which may include some type of digital media content, such as a DVD, a CD, a flash memory, a RAM/ROM, and so on. Device 320 may be configured so that actions by the device 320 to access the data file 340 are detectable by the auditing platform 300. Internet 310 may be used as an interfacing medium between the device 320 and the auditing platform 300.

Auditing platform 300 may comprise a computing platform located remotely from the device 320, and be capable of communicating with device 320 by the internet 310 using any one of several communication protocols, such as, for example, IP, ICMP, and TCP. In another embodiment, auditing platform 300 may be relatively close to the device 320, such as in the same building, and capable of communicating with device 320 over a local area network and/or Intranet (not shown), for example, auditing platform 300 may communicate with and/or monitor the device 320 continuously or periodically, in real-time, or with a time lag. Auditing platform 300 may monitor a usage history of the device 320, for example. Auditing platform 300 may be operated by the owner of a copyright to data file 340 which may be accessed by the device 320. Alternatively, auditing platform 300 may be owned and operated by an agent and/or service provider to such an owner of a copyright to data file 340. Data file 340 may, in an embodiment, include code that may be configured to call out to the auditing platform 300 (over Internet 310, for example) to announce when it is being accessed by the device 320. In another embodiment, a user may cause the device 320 to interact with the auditing platform 300 to purchase access rights to the data file 340.

In a particular embodiment, the auditing platform 300 may search for a device 320 that has accessed protected material without using an open routine defining the proprietary argument.

In yet another embodiment, the auditing platform 300 may search among devices 320 that may be a priori known to not include an open routine defining the proprietary argument. Accordingly, the devices 320 are not genuine and would normally be unable to access protected material. Thus, if a hacker modifies such a device 320 to illegally access the data file 340 by incorporating the open routine defining the proprietary argument, then such illegal access may be detected by the auditing platform 300. The proprietary operating system will be described in detail below.

FIG. 3 is a schematic diagram showing details of the device 320 and data file 340, according to a particular embodiment. Device 320 may include a computing platform 330 that may be configured to carry out various functions, including ones for accessing the data file 340. Alternatively, the computing platform 330 may be dedicated solely for accessing the data file 340. Computing platform 330 may incorporate an operating system 335, which may include various routines, such as an open routine 337, for accessing data file 340. Computing platform 330 may comprise a processor and memory (not shown) for storing and executing machine-readable instructions for hosting one or more applications. Such applications may be adapted to access data file 340 via computing platform 330.

Data file 340 may include a file identifier 350 to distinguish and identify data file 340 from other data files. File identifier 350 may be a file name or an integer key, for example. Data file 340 may also include, or have associated with it, a proprietary string 360, which may include a character string, an integer key, or a pointer to a table that contains at least one character string or integer key. The proprietary string 360 may be included in a header as part of the data file 340, and may be an ASCII name or an integer key, for example. Alternatively, such a proprietary string may be provided separately from data file 340 in, for example, a separate message, which may be typed in a user interface, insertable memory, and/or the like.

In the following discussion, the term “genuine device” implies a device 320 that includes an operating system having an open routine that defines a proprietary argument. Accordingly, the genuine device is configured to access a data file 340 that includes a proprietary string 360. The term “authorized genuine device” implies a genuine device 320 that includes operating conditions to access the data file 340. Such operating conditions may comprise a proprietary argument that matches a proprietary string 360 that is included and/or associated with the data file 340.

On the other hand, a device 320 that is not genuine implies that the device 320 is not configured to access a data file 340 that includes a proprietary string 360. In a particular embodiment, modifying a non-genuine device to become configured to access a data file 340 that includes a proprietary string 360 may entail changing the non-genuine device's operating system to include an open routine 337 that defines at least a file identifier argument and a proprietary argument, for example. Thus, a non-genuine device that includes the open routine 337 with the proprietary argument is itself an indication that may be used to detect that the device is non-genuine.

In view of the discussion above, operating system 335, in an embodiment, may include an open routine 337 that defines multiple arguments which are passed to open routine 337 when it is called by operating system 335. Such arguments may include at least a file identifier argument and a proprietary argument. The open routine 337 may also defines an argument for defining type of access, such as read-only, write, and so on. The file identifier argument and the proprietary argument correspond to the file identifier 350 and the proprietary string 360, respectively, of the data file 340. Open routine 337 locates the data file 340 having the file identifier 350 that matches the file identifier argument. Additionally, open routine 337 may be adapted to conditionally access the data file 340 based, at least in part, on a comparison of the proprietary argument with the proprietary string 360. Accordingly, if the proprietary argument and the proprietary string 360 do not match, then the data file 340 may not be accessed by the device 320 incorporating the open routine 337 using the mismatched proprietary argument. This device 320 is genuine, but unauthorized to access the data file 340.

On the other hand, if the proprietary argument and the proprietary string 360 match, then the data file 340 may be accessed by the device 320 incorporating the open routine 337 using the matching proprietary argument. This device 320 is genuine and authorized to access the data file 340.

If the operating system 335 of the device 320 incorporates an open routine that does not include a proprietary argument, then the data file 340, which includes the proprietary string 360, and the operating system 335 are incompatible with each other. Accordingly, the operating system 335 is incapable of accessing the data file 340 in this situation. This device 320 is not genuine and unauthorized to access the data file 340.

In an embodiment, a hacker may somehow access a data file 340 using an unauthorized device 320. But this illegal access is detectable, such as by the auditing platform 300, as indicated by the access sans the open routine having a proprietary argument.

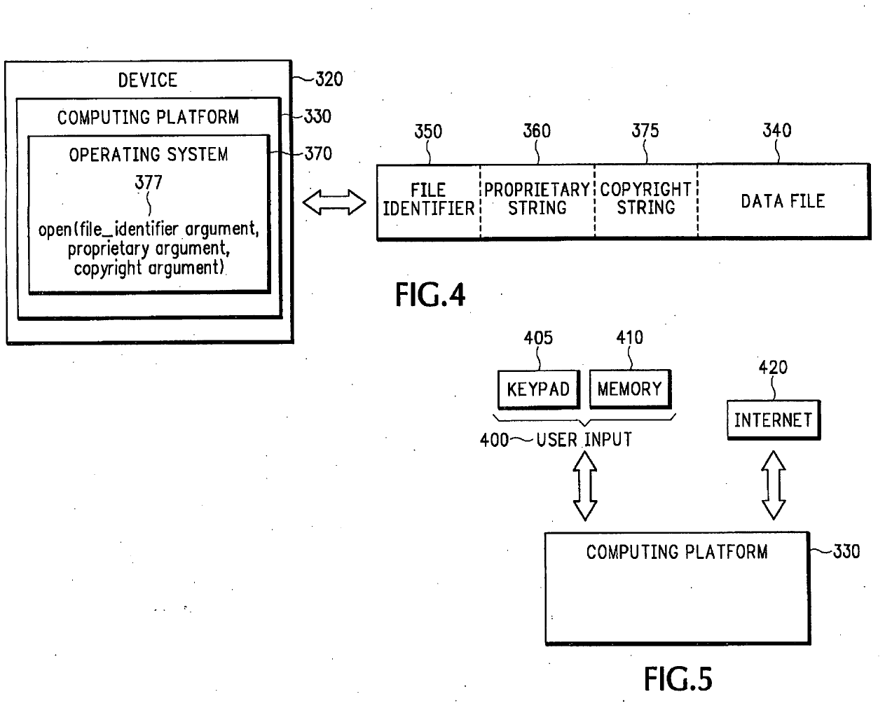

FIG. 4 is a schematic diagram showing details of the device 320 and the data file 340, according to another embodiment. In this embodiment, the operating system 370 may include an open routine 377 that defines at least a file identifier argument, a proprietary argument, and a copyright argument as arguments which may be passed to open routine 377 when it is called. As in the previous embodiment, the file identifier argument and the proprietary argument correspond to the file identifier 350 and the proprietary string 360, respectively, of the data file 340. Additionally, the copyright argument corresponds to a copyright string 375 that is included in, or associated with, the data file 340.

As in the previous embodiment, the open routine 377 of the operating system 370 conditionally accesses the data file 340 based, at least in part, on a comparison of the proprietary argument with the proprietary string 360. In the presently illustrated embodiment, open routine 377 of operating system 370 also determines a presence of the copyright string 375. If the copyright string 375 is present in, or associated with the data file 340, then the open routine 377 will flag the data file 340 as being copyrighted material, and may or may not access the data file 340, depending, in an embodiment, on the outcome of the comparison of the proprietary argument with the proprietary string 360. If the data file 340 does not include a copyright string 375, then the open routine 377 will not flag the data file 340 as being copyrighted.

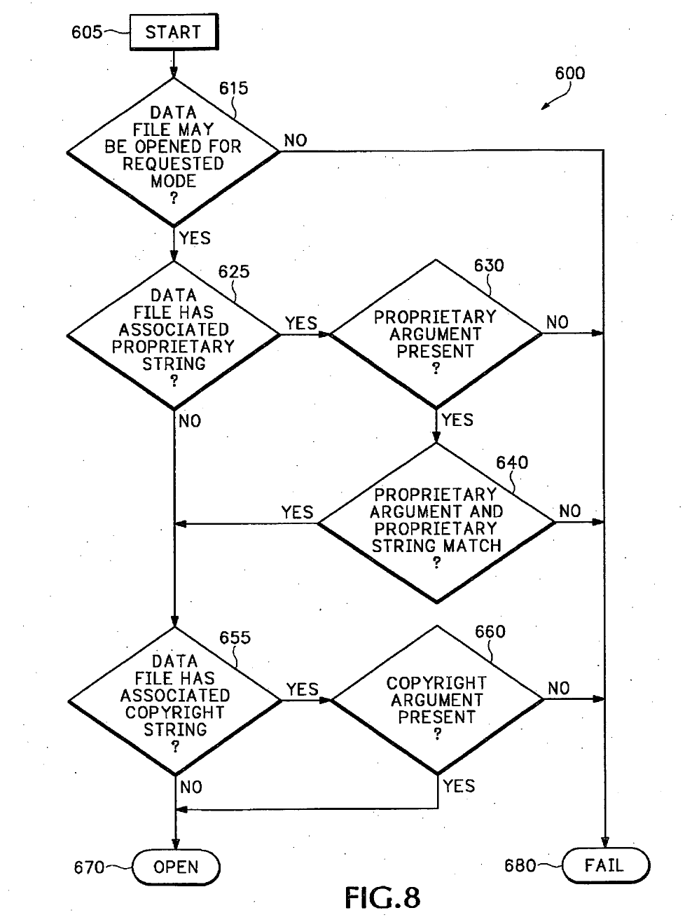

In another embodiment, which is described below and in FIG. 8, if copyright string 375 is present in, or associated with the data file 340, then open routine 377 may fail to access data file 340, depending whether open routine 377 includes a copyright argument. If, however, the data file 340 does not include a copyright string 375, then open routine 377 may access the data file 340. Accordingly, open routine 377 selectively accesses data file 340 based, at least in part, on whether or not the data file 340 has associated with it a copyright string, and not just based on a comparison of the proprietary argument with the proprietary string 360. Of course, any number of outcomes responsive to whether or not a copyright string 375 is associated with the data file 340 is possible, and claimed subject matter is not limited in this respect to the illustrated embodiments.

In other embodiments, the open routine 377 may define additional arguments to correspond to any number of strings or arguments included or associated with the data file 340.

FIG. 5 is a schematic diagram illustrating a user input 400 and internet 420 configured to interact with a computing platform 330, according to an embodiment. Open routine arguments, such as the one included in open routine 377 of the embodiment of FIG. 4, may be received from user input 400 or internet 420, among other possibilities.

For example, a licensee of a proprietary DVD, which may be data file 340, may selectively give permission to access the DVD by supplying a proprietary argument via internet 420 that matches proprietary string 360 associated with the DVD. Or, in another example, the proprietary argument may be provided by a user via user input 400.

User input 400 may be a keypad 405 associated with device 320 that includes computing platform 330, for example. To illustrate an embodiment, the keypad 405 may include controls to access data file 340, which may be a DVD if the device 320 is a DVD player or a CD if the device 320 is a CD player.

User input 400 may also include data stored in a flash or other type of memory 410. For example, a user may store a program in the memory 410 included in device 320 to control access to data file 340, which may comprise a DVD if the device 320 is a DVD player, for example.

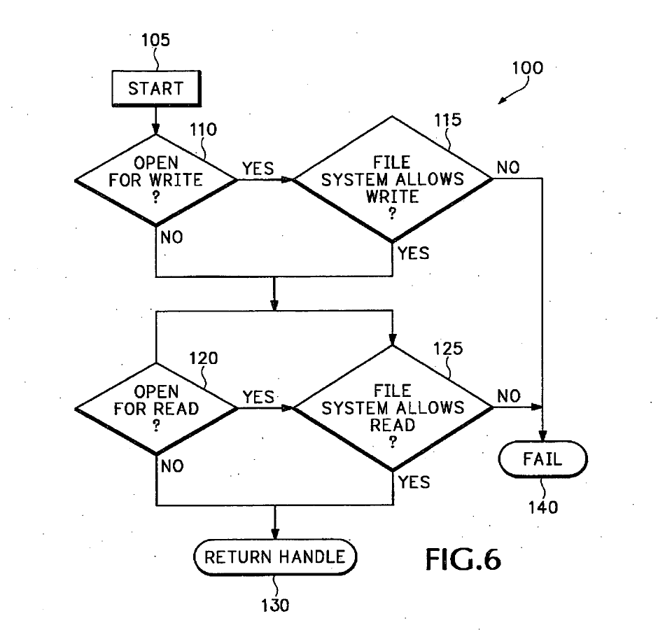

FIG. 6 is a flow diagram illustrating a process 100 for accessing a data file through a general open routine, starting at block 105. At block 110, an operating system determines whether the open routine includes a write request. If so, then the operating system, in block 115, determines whether the data file allows a write procedure. If not, then the open routine will return a Fail, as in block 140. Otherwise, at block 120, the operating system next determines whether the open routine includes a read request. If so, then the operating system, in block 125, determines if the data file allows a read procedure. If not, then the open routine will return a Fail, as in block 140. Otherwise, at block 130, the operating system returns a handle.

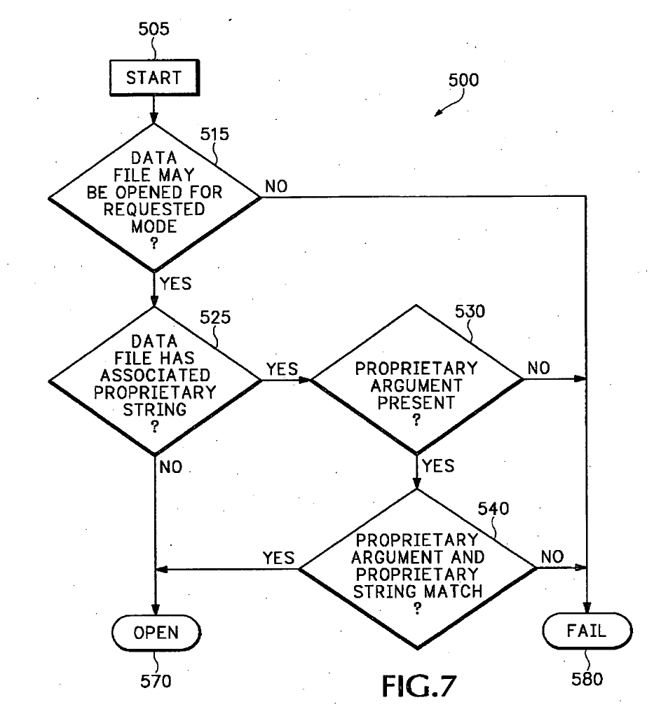

FIGS. 7 and 8 are flow diagrams illustrating processes 500 and 600 for accessing a data file 340 using the open routines 337 and 377, respectively, according to particular embodiments. To briefly review early embodiments, the open routine 377 of operating system 370 includes a copyright argument while open routine 337 of operating system 335 does not.

Referring to FIG. 7, after starting at block 505, operating system 335 determines, at block 515, whether the data file 340 may be opened in the mode called by the open routine 337. Details of this determination may include such blocks 110-125 as shown in FIG. 6, for example. If the data file 340 may not be opened in the mode called by the open routine 337, then open routine 337 will return a Fail, as in block 580. Otherwise at block 525 the operating system 335 next determines whether the data file 340 includes, or has associated with it, a proprietary string 360, as shown in the embodiment of FIG. 3, for example. If so, then if in block 530 the operating system 335 does not include a proprietary argument, then open routine 337 will return a Fail, as in block 580. Otherwise, at block 540, operating system 337 determines if the proprietary argument and the proprietary string 360 match. If not then open routine 337 will return a Fail, as in block 580. Otherwise open routine 337 will open the data file 340 as in block 570.

Accordingly, the open routine 337 of the operating system 335 conditionally accesses the data file 340 based, at least in part, on a comparison of the proprietary argument with the proprietary string 360.

Referring to FIG. 8, after starting at block 605, operating system 370 determines, at block 615, whether the data file 340 may be opened in the mode called by the open routine 377. Details of this determination may include such steps 110-125 as shown in FIG. 6, for example. If the data file 340 may not be opened in the mode called by the open routine 377, then open routine 377 will return a Fail, as in block 680. Otherwise at block 625 the operating system 370 next determines whether the data file 340 includes, or has associated with it, a proprietary string 360, as shown in the embodiment of FIG. 4, for example. If so, then if in block 630 the operating system 370 does not include a proprietary argument, then open routine 377 will return a Fail, as in block 680. Otherwise, at block 640, operating system 370 determines if the proprietary argument and the proprietary string match. If not then open routine 377 will return a Fail, as in block 680. Otherwise at block 655 the operating system 370 next determines whether the data file 340 includes, or has associated with it, a copyright string 375, as shown in the embodiment of FIG. 4, for example. If so, then if in block 660 the operating system 370 does not include a copyright argument, then open routine 377 will return a Fail, as in block 680. Otherwise open routine 377 will open the data file 340 as in block 670.

Accordingly, the open routine 377 of the operating system 370 conditionally accesses the data file 340 based, at least in part, on a comparison of the proprietary argument with the proprietary string 360 and a presence of the copyright string 375. Of course, operating system 335 or 370 may respond in any number of ways as to whether or not a copyright string 375 is associated with data file 340 and as to whether or not the proprietary argument included in open routine 337 matches proprietary string 360 associated with data file 340, and claimed subject matter is not limited in this respect to the illustrated embodiments.

Soft DRM technology as presented in some of the embodiments above can delivery as much protection as complex and expensive hard DRM technologies at a fraction of the cost.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

1. A device comprising:
a computing platform, said computing platform hosting an operating system comprising an open routine,
wherein said open routine defines at least a file identifier argument and a proprietary argument, said open routine being adapted to conditionally access a data file associated with said file identifier argument based, at least in part, on a comparison of said proprietary argument with a proprietary string associated with said data file.

2. The device of claim 1, wherein said open routine further defines a copyright argument, said open routine being adapted to conditionally access said data file associated with said file identifier argument based, at least in part, on a comparison of said copyright argument with a copyright string associated with said data file.

3. The device of claim 1, wherein said proprietary string is a character string.

4. The device of claim 1, wherein said proprietary string is an integer key.

5. The device of claim 1, wherein said proprietary string is a pointer to a table that contains at least one character string or integer key.

6. The device of claim 1, wherein said proprietary argument is included in an argument list of application source code provided by a user of said device.

7. The device of claim 1, wherein said operating system is adapted to receive said proprietary argument from the internet.

8. The device of claim 1, wherein said data file comprises video data.

9. The device of claim 1, wherein said data file comprises audio data.

10. The device of claim 9, wherein said data file comprises video data.

11. The device of claim 8, wherein said device comprises a video player.

12. The device of claim 9, wherein said device comprises an audio player.

13. The device of claim 10, wherein said device comprises an audio-video player.

14. The device of claim 1, wherein accessing said data file includes reading the data file.

15. The device of claim 1, wherein accessing said data file includes writing to the data file.

16. The device of claim 1, wherein accessing said data file includes executing the data file.

17. The device of claim 1, wherein accessing said data file includes modifying the data file.

18. The device of claim 1, wherein accessing said data file includes copying the data file.

19. A method comprising:
receiving information from a device having accessed a data file; and
determining from said received information whether the device is authorized to access the data file, said received information being descriptive of an open routine used to access said data file, said open routine being included in an operating system hosted on said device.

20. The method of claim 19, wherein said open routine defines at least a file identifier argument and a proprietary argument, said open routine being adapted to conditionally access said data file associated with said file identifier argument based, at least in part, on a comparison of said proprietary argument with a proprietary string associated with said data file.

21. The method of claim 19, wherein the data file comprises video data.

22. The method of claim 19, wherein the data file comprises audio data.

23. The method of claim 22, wherein said data file comprises video data.

24. The method of claim 21, wherein the device comprises a video player.

25. The method of claim 22, wherein the device comprises an audio player.

26. The method of claim 23, wherein said device comprises an audio-video player.

27. An article comprising:
a storage medium comprising machine-readable instructions stored thereon which, if executed by a computing platform, are adapted to cause said computing platform to:
receive information from a device having accessed a data file; and
determine from said received information whether the device is authorized to access the data file, said received information being descriptive of an open routine used to access said data file, said open routing being included in an operating system hosted on said device.

28. The article of claim 27, wherein said open routine defines at least a file identifier argument and a proprietary argument, said open routine being adapted to conditionally access said data file associated with said file identifier argument based, at least in part, on a comparison of said proprietary argument with a proprietary string associated with said data file.

29. The article of claim 27, wherein the data file comprises video data.

30. The article of claim 27, wherein the data file comprises audio data.

31. The article of claim 30, wherein said data file comprises video data.

32. The article of claim 29, wherein the device comprises a video player.

33. The article of claim 30, wherein the device comprises an audio player.

34. The article of claim 31, wherein said device comprises an audio-video player.
